(19) United States
(12) Patent Application Publication
(10) Pub. No.: US 2014/0342761 A1
(43) Pub. Date: Nov. 20, 2014

(54) Method and system for delivering optimal rich media content using mobile messaging

(71) Applicant: Cezary Kolodziej, Deer Park, IL (US)

(72) Inventor: Cezary Kolodziej, Deer Park, IL (US)

(21) Appl. No.: 14/121,116

(22) Filed: Apr. 25, 2012

(51) Int. Cl. H04W 4/14; H04L 29/06

(52) U.S. Cl. CPC H04W 4/14; H04L 65/60
USPC 455/466

(57) ABSTRACT

The invention consists of a method and system for delivering optimal rich media content to a mobile device using one of multiple messaging channels. The invention includes dynamically detecting the capabilities of the mobile device and the wireless network that the mobile device is using, and then delivering an optimal choice among multiple variations of a set of rich media content. The variations in the set of rich media content may be composed statically or generated dynamically. The rich media content can be delivered via SMS, MMS or mobile application push notification.

### BACKGROUND OF THE INVENTION

Marketers have long used SMS to deliver branded content to interested consumers. While SMS has reached wide consumer acceptance, it is also limited to 160 characters of text. A common practice has been to include short links to web sites that provide additional text and rich content. This practice works well in many cases, however it requires a mobile user to click on a link and wait for the web site to display on their device. Web sites used in this manner ideally would be optimized for the small display of the specific device of the mobile user, but in practice users are unfortunately too often directed to web sites designed for large screens which render poorly on mobile devices. Moreover, many mobile devices have inadequate or non-existent web browsers while other mobile devices do not have mobile service that includes wireless data, thus limiting the usefulness of such web links.

MMS was devised as a logical progression of SMS, which promised to bring a rich media experience to the well-established ubiquity of SMS market reach. MMS has mostly fulfilled this promise in the context of person-to-person (P2P) messaging, with which consumers can easily send images or short videos they capture on their mobile device to each other. However, MMS has been less successful as a marketing channel because the rich media content has been challenging to adapt to all devices in a manner that preserves branded image content such as logos. The content adaptation employed for user generated P2P content consists of simple image resizing which works well for photographs but does not work well for branded image content.

### SUMMARY OF THE INVENTION

The invention consists of a method and system for delivering optimal rich media content using various forms of messaging to a mobile device over a wireless network. Multiple forms of messaging are employed, including SMS, MMS, and mobile application notifications, in order to maximize the user experience available to a given mobile device. The capabilities of the mobile device are detected and the optimal user experience is chosen. Multiple forms of rich media content are employed such that the optimal form may be delivered to a given mobile device according to its physical screen size and media playback capabilities.

### BRIEF DESCRIPTION OF THE DRAWINGS

The accompanying drawings provide an overview of the environment in which the invention is defined and describe the approach used.

FIG. 1 provides an overview of the environment in which the invention is defined. The invention describes a messaging system that delivers optimal rich media content using one or more forms of mobile messaging. All forms of messaging employed by the invention are defined in the context of a wireless network in which messages are delivered to a mobile device. Various wireless messaging protocols are used which are described below. The invention includes a database of various forms of rich media content to be delivered to a mobile device as well as a database of mobile device types with their capabilities and preferred forms of rich media content.

FIG. 2 defines the decision flow of invention that is used to determine the optimal form of rich media content to be delivered to a specific mobile device. The detailed steps in the flow will be described below.

### DETAILED DESCRIPTION OF THE PREFERRED EMBODIMENTS

The invention consists of a method and system for delivering optimal rich media content using various forms of messaging to a mobile device over a wireless network. Multiple forms of messaging are employed in order to maximize the user experience available to a given mobile device. Multiple forms of rich media content are employed such that the optimal form may be delivered to a given mobile device according to its physical screen size and media playback capabilities.

Three forms of mobile messaging are employed as described below.

(1) SMS (Short Message Service) is the most ubiquitous form of mobile messaging on virtually all mobile devices on all networks. While the ubiquity of SMS is a huge benefit for marketers to be able to reach all possible users, SMS is also limited to 160 text characters.

(2) MMS (Multimedia Messaging Service) leverages the ubiquitous nature of SMS while extending the content delivery capabilities to include image, audio and video content. In practice, MMS is almost as ubiquitous as SMS, however devices vary enormously in their ability to render varying sizes and formats of multimedia content.

(3) Mobile application notifications allow a message to be pushed to a mobile device that subsequently directs the user to engage with a custom mobile application in order to display rich media content. A mobile application offers a more immersive user experience compared to messaging, however mobile applications require custom development for many mobile platforms, require users to explicitly install the applications, and not all mobile devices offer a development platform on which to deliver custom mobile applications.

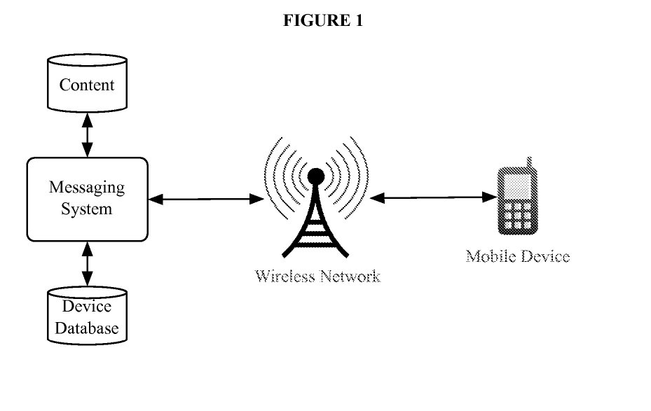

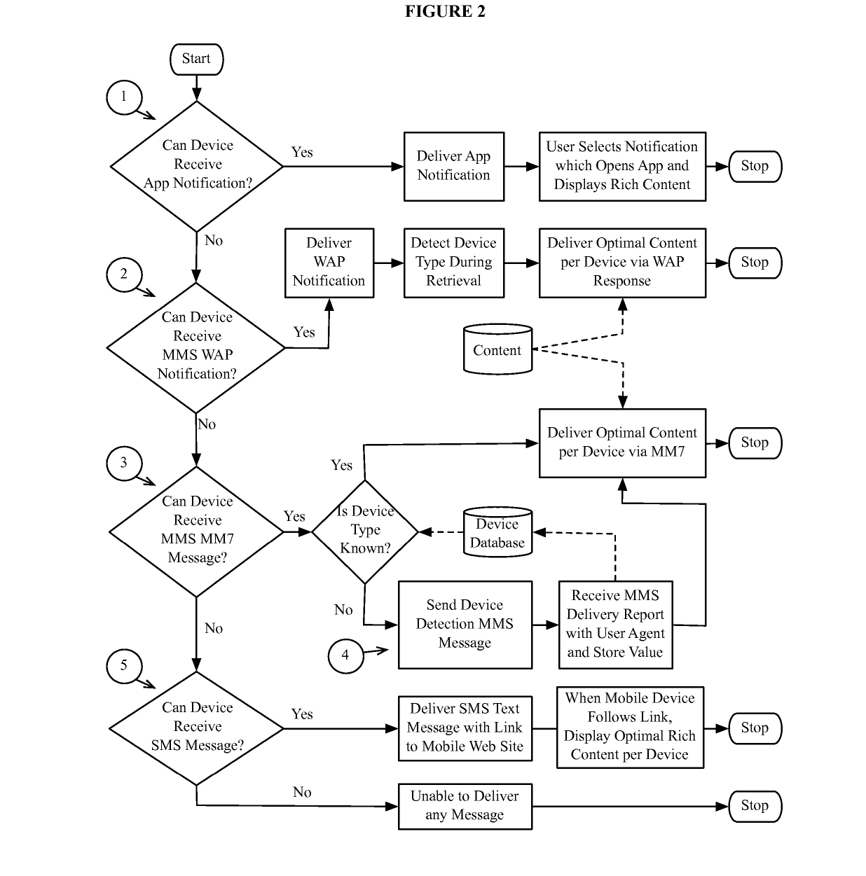

FIG. 2 describes a decision process to determine which form of messaging to employ for a given mobile device based on the capabilities of the device. The first choice, shown in point (1) of FIG. 2, consists of sending an application push notification if possible. If a mobile device has installed a mobile application that can receive a push notification, then the application would register this capability with the messaging system depicted in FIG. 1. When the messaging system would need to send a message to such a mobile device, the messaging system would check for this registered capability and if it exists then the messaging system would send the device a push notification. Upon receipt of the push notification, a mobile application may take one of multiple actions, including the display of rich media content within the context of the mobile application.

The next choice for determining the optimal form of messaging to employ for a given device consists of determining the ability to deliver MMS to the mobile device. This choice is depicted in point (2) of FIG. 2. The invention includes multiple methods to deliver MMS to a mobile device. The delivery of an MMS message inherently depends on first delivering a WAP (Wireless Access Protocol) notification. A WAP notification is a binary encoded SMS message that directs a mobile device to retrieve the content of an MMS message from a location specified within the body of the notification. The retrieval of the MMS message occurs using a standard HTTP GET request that includes information identifying the mobile device type. When a mobile device requests the retrieval of an MMS message, the messaging system of this invention provides the device with rich media content that is optimized for the specific mobile device type. The optimized rich media content may be created statically before the notification is sent, or it may be created dynamically when the request is received, or a combination of approaches may be employed in which portions of the content are statically created and other portions are dynamically composed based on either the device type or the identity of the mobile device user.

Some wireless networks cannot support sending a WAP notification from an external messaging system as depicted in FIG. 1. Such wireless networks may instead support sending MMS content via a store and forward interface referred to as MM7 by the MMS standards. This choice is depicted in point (3) in FIG. 2. When the messaging system depicted in FIG. 1 sends an MMS message to a mobile device via MM7, the wireless network accepts the message for delivery without providing any feedback to the messaging system regarding the recipient's mobile device type. Instead, feedback is provided back to the messaging system after the MMS message is delivered to the mobile device in the form of an MMS Delivery Report that identifies the mobile device type.

To overcome this limitation, the messaging system first sends a special Device Detection MMS message that is only intended for the purpose of determining the mobile device type. This step is depicted in point (4) in FIG. 2. When the messaging system receives an MMS Delivery Report from the wireless network, the messaging system stores the mobile device type in a Device Database. This Device Database may be queried for future attempts to deliver an MMS message to a mobile device in order to avoid the extra step of sending a special Device Detection MMS message. Once the mobile device type is known, the messaging system of this invention sends an MMS message to the mobile device via the MM7 interface, and the message includes rich media content that is optimized for the specific mobile device type. The optimized rich media content may be created statically before the notification is sent, or it may be created dynamically when the request is received, or a combination of approaches may be employed in which portions of the content are statically created and other portions are dynamically composed based on either the device type or the identity of the mobile device user.

Some wireless networks cannot support sending either a WAP notification or an MMS message via MM7 from an external messaging system as depicted in FIG. 1. Such wireless networks may instead support sending only text based SMS. This choice to send an SMS text message is depicted in point (5) in FIG. 2. When the messaging system depicted in FIG. 1 sends an SMS message, it may contain a link to a web site. If the mobile device is able to follow the web site link, then the web site would display rich media content in a manner that is optimized for the display capabilities of the mobile device.

1. A method for detecting the capabilities of a mobile device by sending an MMS message to a mobile device via an MMSC, receiving a delivery report with a user agent name, and using the name to reference a database of mobile device capabilities.

2. A method for detecting the capabilities of a mobile device by sending an MMS WAP notification message to a mobile device via an SMSC, receiving a MMS retrieval request from the mobile device that contains a user agent name, and using the name to reference a database of mobile device capabilities.

3. A method for detecting the capabilities of a mobile device by querying a database that stores the last known capabilities for a device.

4. A method for updating the database described in claim 3 based on recent interactions with a mobile device.

5. A method for choosing an image from a set of similar images such that the chosen image is optimized for the screen resolution of a mobile device.

6. The method of claim 4, wherein the chosen content is video.

7. The method of claim 4, wherein the chosen content is audio.

8. The method of claim 4, wherein the chosen content is text.

9. A method for dynamically creating an image that is optimized for a specific mobile device.

10. The method of claim 9, wherein the chosen content is video.

11. The method of claim 9, wherein the chosen content is audio.

12. The method of claim 9, wherein the chosen content is text.

13. A method for delivering optimized image content per the method of claim 5 to a mobile device via MMS.

14. The method of claim 13, wherein the content is derived via claim 9.

15. A method for delivering optimized video content per the method of claim 6 to a mobile device via MMS.

16. The method of claim 15, wherein the content is derived via claim 10.

17. A method for delivering optimized audio content per the method of claim 7 to a mobile device via MMS.

18. The method of claim 17, wherein the content is derived via claim 11.

19. A method for delivering optimized image content per the method of claim 5 to a mobile device via SMS with a link to a mobile optimized web site.

20. The method of claim 19, wherein the content is derived via claim 9.

21. A method for delivering optimized video content per the method of claim 6 to a mobile device via SMS with a link to a mobile optimized web site.

22. The method of claim 21, wherein the content is derived via claim 10.

23. A method for delivering optimized audio content per the method of claim 7 to a mobile device via SMS with a link to a mobile optimized web site.

24. The method of claim 23, wherein the content is derived via claim 11.

25. A method for delivering optimized image content per the method of claim 5 to a mobile device via a mobile application directed notification.

26. The method of claim 25, wherein the content is derived via claim 9.

27. A method for delivering optimized video content per the method of claim 6 to a mobile device via a mobile application directed notification.

28. The method of claim 27, wherein the content is derived via claim 10.

29. A method for delivering optimized audio content per the method of claim 7 to a mobile device via a mobile application directed notification.

30. The method of claim 29, wherein the content is derived via claim 11.
